(19) United States
(12) Patent Application Publication
(10) Pub. No.: US 2023/0032429 A1
(43) Pub. Date: Feb. 2, 2023

(54) SYSTEM AND METHOD FOR PREDICTING CUSTOMER PROPENSITIES AND OPTIMIZING RELATED TASKS THEREOF VIA MACHINE LEARNING

(71) Applicant: Acqueon Technologies Inc., San Jose, CA (US)

(72) Inventors: Ashok Raj Susairaju, Thiruvanmiyur (IN); Ashish Koul, San Jose, CA (US)

(21) Appl. No.: 17/385,965

(22) Filed: Jul. 27, 2021

(51) Int. Cl. G06Q 10/06; G06N 20/00

(52) U.S. Cl. CPC G06Q 10/06312; G06Q 10/06316; G06Q 10/0637; G06N 20/00

(57) ABSTRACT

A system and method that provides predictions about the propensity of customers to answer a communication, pay an outstanding bill, and remain a customer. Furthermore, the system and method use propensity predictions to optimize the order of tasks that are carried out by integrated business systems. During a specific time-block, an optimization may reconfigure an auto-dialer to contact only the most likely customers who are both willing to pay and who are most likely to answer, as one example. Another example may be the reordering of tasks provided to a call agent's computing device. The system uses machine learning for the predictions and optimizations, and continuously and automatically updates the machine learning models over time.

### BACKGROUND

### Field of the Art

The disclosure relates to the field of machine learning, and more particularly to the field of predictions and optimizations.

### Discussion of the State of the Art

Core challenges faced by businesses have not changed since the first businesses were instated at least five millenniums ago. Problems arising from customer service and customer retention, to ensuring customers make timely payments, still haunt all businesses in the 21^{st} century. However, most modern-day businesses still operate with 20^{th} century technology.

Regarding the customer service aspect, it is the primary intent for any customer service department to maximize the resources of its contact center. In today's world, it is more challenging than ever to contact customers, whether selling a new product or collecting past due payments; hence, automated dialers came into existence and since then have become an integral part of most outbound collection, telemarketing, and outbound customer service strategies. However, these devices working alone can neither determine when to contact which customers nor identify the best communication mode to use.

Additionally, customer retention is an increasingly pressing issue in today's ever-competitive commercial arena. Companies are eager to develop a customer retention focus and create initiatives to maximize long-term customer value. Specifically, customer churn risk is at the forefront of customer retention focus. However, current day retention strategy best-practices are still problematic, often leading to inconsistent results. Furthermore, collection is another age-old problem among businesses and still accounts for a significant amount of lost capital. Call center administrators want to maximize their agent resources by making sure that they are calling customers who are willing to pay their bills. There is currently no system that can accurately predict a range of customer's propensities to pay, answer, and stay within a company and further optimize existing technologies around those predictions.

What is needed is a system and method that uses machine learning to predict a customer's propensity to pay, propensity to churn, and the best time and mode to contact and subsequently use those predictions to reconfigure business technologies.

### SUMMARY

Accordingly, the inventor has conceived and reduced to practice, a system and method that provides predictions about the propensity of customers to answer a communication, pay an outstanding bill, and remain a customer. Furthermore, the system and method use propensity predictions to optimize the order of tasks that are carried out by integrated business systems. During a specific time-block, an optimization may reconfigure an auto-dialer to contact only the most likely customers who are both willing to pay and who are most likely to answer, as one example. Another example may be the reordering of tasks provided to a call agent's computing device. The system uses machine learning for the predictions and optimizations, and continuously and automatically updates the machine learning models over time.

According to a first preferred embodiment, a system for predicting propensities and optimizing tasks related thereof is disclosed, comprising: a propensity prediction and optimization platform comprising at least a plurality of programming instructions stored in a memory of, and operating on at least one processor of, a computing device, wherein the plurality of programming instructions, when operating on the at least one processor, causes the computing device to: receive a plurality of customer records; store the plurality of customer records; use one or more machine learning modules on the plurality of customer records to: predict the most probable block of time of each day each customer in the plurality of customer records will engage in communication; predict the most probable means of communication for each block of time for each customer in the plurality of customer records; predict the propensity to churn for each customer in the plurality of customer records; and predict the probability of each customer in the plurality of customer records to pay a bill; sort the plurality of customer records according to one or more objectives; and send at least one customer record from the sorted customer records to a communications device, wherein the communications device acts upon the at least one customer record.

According to a second preferred embodiment, a method for predicting propensities and optimizing tasks related thereof is disclosed, comprising the steps of: receiving a plurality of customer records; storing the plurality of customer records; predicting the most probable block of time of each day each customer in the plurality of customer records will engage in communication; predicting the most probable means of communication for each block of time for each customer in the plurality of customer records; predicting the propensity to churn for each customer in the plurality of customer records; and predicting the probability of each customer in the plurality of customer records to pay a bill; sorting the plurality of customer records according to one or more predetermined objectives; and sending at least one customer record from the sorted customer records to a communications device, wherein the communications device acts upon the at least one customer record, wherein the communications device acts upon the at least one customer record.

According to various aspects; wherein the communications device is an auto dialer; wherein the communications device auto-generates a communication selected from the group consisting of email, text messaging, social media, interactive voice response, phone call, push notifications, and instant messaging; wherein the communications device is a call center computing device; wherein predictions are made using previously stored customer records; wherein the plurality of customer records is first preprocessed for ingestion into the one or more machine learning modules; wherein at least one of the one or more machine learning modules are configured to make at least one prediction selected from the group consisting of propensity to pay, propensity to churn, best time to contact, and best method of contact; wherein data between the communications device and the propensity prediction and optimization platform is facilitated by an application programming interface; wherein the communications device is part of the propensity prediction and optimization platform; further receiving data that is not customer records.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for a propensity prediction and optimization platform.

FIG. 2 is a block diagram illustrating an exemplary data architecture used in a propensity prediction and optimization platform.

FIG. 3 is a block diagram illustrating an exemplary analytical engine used in a propensity prediction and optimization platform.

FIG. 4 is a block diagram illustrating an exemplary machine learning architecture in a propensity prediction and optimization platform.

FIG. 5 is a flow diagram illustrating an exemplary implementation of a propensity prediction and optimization platform.

FIG. 6 is a flow diagram illustrating an exemplary method for predicting and optimizing customer propensities.

FIG. 7 is a flow diagram illustrating one aspect of an exemplary implementation of the method for predicting and optimizing of customer propensities.

FIG. 8 is a flow diagram illustrating another aspect of an exemplary implementation of the method for predicting and optimizing of customer propensities.

FIG. 9 is a table illustrating an exemplary customer dataset for use with at least the BTTC model.

FIG. 10 is a flow diagram illustrating an exemplary method for quick onboarding of users of a propensity prediction and optimization platform.

FIG. 11 is a block diagram illustrating one aspect of an exemplary user interface used in a propensity prediction and optimization platform.

FIG. 12 is a block diagram illustrating an exemplary hardware architecture of a computing device.

FIG. 13 is a block diagram illustrating an exemplary logical architecture for a client device.

FIG. 14 is a block diagram showing an exemplary architectural arrangement of clients, servers, and external services.

FIG. 15 is another block diagram illustrating an exemplary hardware architecture of a computing device.

### DETAILED DESCRIPTION

The inventor has conceived, and reduced to practice, a system and method that provides predictions about the propensity of customers to answer a communication, pay an outstanding bill, and remain a customer. Furthermore, the system and method may use propensity predictions to optimize the order of tasks that are carried out by integrated business systems. An example may be that during a specific time-block, an optimization task may reconfigure an auto-dialer to contact only the most likely customers who are both willing to pay and who are most likely to answer. Another example may be the reordering of tasks provided to a call agent's computing device. The system uses machine learning for the predictions and optimizations, and continuously and automatically updates the machine learning models over time.

The primary intent for any contact center is to maximize customer service. In today's world, it is more challenging than ever to contact customers whether selling a new product or collecting past due payments; hence, automated dialers came into existence and since then have become an integral part of most outbound collection, telemarketing, and outbound customer service strategies.

However, these devices working alone can neither determine when to contact which customers nor identify the best phone number (mode) to use. And that's where the Best Time/Right Person to Contact, identified henceforth as the acronym “BTTC”, module comes in. BTTC is a machine learning model that predicts the right time to contact a customer and the best mode (phone number, email ID, etc.) within each channel (e.g., voice, email, SMS) to use for each time period during the day.

Additionally, customer retention is an increasingly pressing issue in today's ever-competitive commercial arena. Companies are eager to develop a customer retention focus and initiatives to maximize long-term customer value. Accordingly, as disclosed herein, customer churn risk is captured by a retention model (propensity to churn (P2C) model) that uses segmentation to assist in relationship-building, retention strategy and profit planning.

A propensity to churn (P2C) module analyzes at the past behavior of previous and existing customers to make future predictions. To avoid losing customers, a company needs to examine why its customers have left in the past. Likewise, ‘Product Churn’ is defined from the company's perspective as the loss of customers with regards to a specific product within the company. This could be due to the customer “upgrading”, switching to another product within the same company, dropping the product altogether, or switching to a competitor's product. However, churn in these instances only considers voluntary leave by the customer and does not consider involuntary removal. Some examples of involuntary removal include the removal of a customer from a product due to non-payment or the sunsetting of a product. Moreover, the P2C model also predicts the order of churn for the customers, and, as a by-product, a “time until churn” estimate.

Collections is an age-old problem, but machine learning puts a new spin on this ever-competitive commercial arena. Call center administrators want to maximize their agent resources by making sure that they are calling customers who are willing to pay their bills. Looking at customer demographics, segmentations, similar customers, the individual payment history of a customer, and other data points, AI can not only provide guidance on who is likely to pay anything but also give an idea of how much the customer will be willing to pay.

The propensity to pay (P2P) model is built to determine a customer's payment patterns and ability to pay. The P2P model contains multiple machine learning and statistical models and is deployed to determine the probability that a customer will make any non-zero payment against a given bill and if a reminder is likely to help the customer to pay. According to one embodiment, if the customer is likely to pay anything, then an expected payment amount is created and also calculated separately to measure the amount that is liable to get collected at the stipulated time. According to another embodiment, if the customer is likely to pay anything, two additional expectations are further created: the expected payment amount, and a time-related expectation for the payment (not when they will pay, but if they will pay by X date where X is dynamic and supplied by the user).

Furthermore, these models are used collectively within a propensity prediction and optimization platform that may be integrated into already existing modern-day call center and business infrastructures. Various implementations are anticipated such as cloud-based, on-premises, or a hybrid of the two. The propensity prediction and optimization platform is a unified platform for predictions, campaign management, dialing, and messaging and built on a rich set of customer data. The propensity prediction and optimization platform can act both as a stand-alone solution with exposed API endpoints or as an add-on within our other products. It features efficient prediction dialing with strict adherence to applicable regulations and fully automated end-to-end interaction lifecycle starting from record ingestion to prediction to dialing. Predictions are manifested from machine learning models that ingest multidimensional datasets which further inform one or more additional machine learning models in order to optimize agent tasking on a daily basis. The following is a description of the three machine learning modules (BTTC, P2C, and P2P) used in one embodiment.

BTTC is a machine learning module configured to predict the right time to contact a customer and the best mode (phone number, email ID, etc.) within each channel (e.g., voice, email, SMS) to use for each time period during the day. Application of the Best Time to Call (BTTC) model involves building an automated engine which aims at reducing the call retry attempts and maximizing the successful call connections by predicting the best time slot during which a customer can be approached during the day, and recommending the right phone number to be used during the best time slot during which the call would be made. The dialer uses the above intelligence to dial out the calls at the most suitable time when the customer is expected to answer there improving the efficiency.

The BTTC model is defined as a classification problem that determines a multiclass target, i.e., the best time slot and the corresponding mode type through which the customer can be approached for a call. The target variable here, timeslot, may be derived from the dialer time on grouping the time into intervals of 15 mins time slot, as one example. The application supports data from different time zones across the globe and hence the target variable may be defined against 96 classes, i.e., 15 mins time window on 24 hours (24*4). This is one example of a default timeslot cadence (15 minute time windows), but it could easily be adjusted to fewer timeslots in a day or more, or as desired. This time window definition here is configurable and is recommended be set in the initial model building stage. The model will be developed based on the configured time interval. Any update on the interval that may need to be attempted at a later stage will call for a rebuilding exercise on the model. The mode type is added as an independent variable into the model and hence the time slot prediction is done against the mode types available for the customer. The model is built against the past contact history variables, customer specific attributes and campaign related variables to predict the best time slot.

One use case comprises call history details. Past call history patterns, contact details and campaign details may be used to predict the best time to contact a customer. Data from the LCM (List & Campaign Manager) database is used primarily here. It helps business to gauge the call picking patterns of customers and use this to information to improve the efficiency in dialing out to the customer. Another use case is finding similar customer BTTC slots. BTTC slots across similar type customers will help in determining the BTTC slots of unknown customers whose data is not present in the LCM database. This will act as the first gauge mechanism to dial out calls on unknown contacts. Yet another use case is finding similar Campaigns BTTC slots. BTTC slots across campaigns will help business evaluate the effectiveness of targeting such campaigns on customers. Yet another use case is determining agent effectiveness on outbound calls. Agent effectiveness on connecting to customers on campaigns can be effectively gauged through BTTC slots and their outcomes. And yet one more use case is weekday wise seasonality. Weekday wise seasonality patterns on calls can be used to effectively gauge if day of week also contribute to the BTTC patterns of customers. This can further be tied effectively for effectively managing calls between customers.

Consider the following exemplary equation to understand the “Target” and “Features” associated with a BTTC model: Phone Success=Customer Call History+Customer Profile+Campaign Details+Interaction History. Here, Phone Success is the target variable and Customer Call History, Customer Profile, Campaign Details, and Interaction History are features.

Assume Phone Success is divided into Yes/No or 1/0. In machine learning, this is a binary classification. A binary classification means the target has exactly two possible values, and each record is assigned to one and only one target label. The machine learning model predicts the probability that a new observation is in either class and returns the class with the highest probability. To wit, an outbound call can either be answered or not. The model will predict the probability of both that the call will be answered and that the call will not be answered (i.e., 113 probability that the call is answered). It returns the class (answered, not answered) most likely to be true, and the associated probability between 0 and 1.

The below table illustrates a list of exemplary business data categories considered while drawing the possible list of variables and scenarios that go into a model for BTTC module. This table is non-exhaustive and here for exemplary purposes.

| Business Category Name | Business Category Description |
|---|---|
| Customer Call History | Understand the patterns related to when the customer calls the |
| | company, when the customer answers a company call, when the |
| | customer does not answer a company call, and the phone numbers |
| | (modes) used at each interaction. |
| Customer Profile | Understand customer demographics including geography, income level, |
| | education level, and other profile details to identify direct impact on |
| | success rates as well as identifying similar customer success rates. |
| Customer Feedback or Net | Understand how the customer feels about the company; this might be |
| Promotor Score (NPS) | estimated or have other proxies if an NPS or feedback does not exist by |
| | the customer such as sentiment analysis on conversations relating to the |
| | product, referrals by the customer to someone else, usage of products, |
| | on-time payment frequencies, similar customer NPS scores, or some |
| | other format. |
| Campaign Details | Understand the campaign goals, details, history, and rules to identify the |
| | impact of customer success rates and/or similar campaigns |
| Passive Interaction History | Understand how often the customer uses available resources that do not |
| | require agent skills such as website usage, app usage, IVR usage, etc. |

The following is a table of exemplary features that may be considered for analysis:

| | | |
|---|---|---|
| CustomerID | CampaignID | CallType |
| CustomerIsActive | CampaignActiveFlag | CampaignKey |
| CustomerRegistrationDate | CampaignGoal | ConditionID |
| CustomerDeregistrationDate | InteractionID | ContactTries |
| VoiceHomePhoneAvailableFlag | InteractionThreadID | DialerTime |
| VoiceMobilePhoneAvailableFlag | ResolutionThreadID | EmailThreadID |
| ProductFamily | ChannelID | IsComplianceDNC |
| ProductDeregistrationDate | DispositionCode | IsLitigated |
| InteractionDirection | IsRightParty | Mode |
| VoiceWorkPhoneAvailableFlag | CallbackRetries | ZoneName |

BTTC models may include one or more separate models; however, according to one embodiment, three types of models are disclosed, which are a full model, persona model, and a call history model. According to one embodiment, the full model may only be used for those customers who have been dialed out at least 5 times in the past. This will look at customer's specific relationship history with the business among other features as described above in the Business Categorization section. The persona model is for new customers with insufficient personal historical information. One definition of new customer may be any customer with less than 5 customer interactions, as an example. The model may use, instead, the churn history of similar customers with longer history in combination with the customer's demographics and other features to predict the likelihood of churn for newer customers. The call history model will be considered only for blind leads who have been contacted multiple times in the past and are not a customer yet.

Further details regarding the call history model include contacts that are called multiple times but are not officially considered customers. As such, these contacts may not exist within the CRM (Customer Relationship Management) since the customer has no official relationship with the company. However, the call history model may have called the phone number before in a previous campaign or even previously within the same campaign. It is important to try to utilize this information when available. Hence, the call history model will consider the customer demographics, but more importantly, it will also consider the call history of the contact such as features like, but not limited to, previous success rates, channels used, times called, and analogous historical information from similar contacts who also are not customers. It important to note that one or two previous calls does not make a pattern, so while it can be used, it cannot be relied upon by itself. In that case, the model would rely more on historical information on similar customers. In the case when no historical contact information exists for a contact, the model would switch to the persona model.

Regarding the persona model, not every contact will have historical records. Some campaigns are based on new leads with no data to use as features, contain brand new customers whose segmentation is a blank or null value, or will contain previously unseen values as features. That is when the model can only rely on general demographics or variables related to customers' characteristics. Demographic segmentation divides the market into smaller categories based on factors such as age, gender, area code, zip code, race, homeownership, and level of education etc. Specifically, demographic data relies on describing a customer without having to know contact history or the relationships between the customer at the company. Using only these pre- known demographics about current customers to build a persona model, any campaign with cold contacts or new customers can still utilize at least some version of a BTTC module.

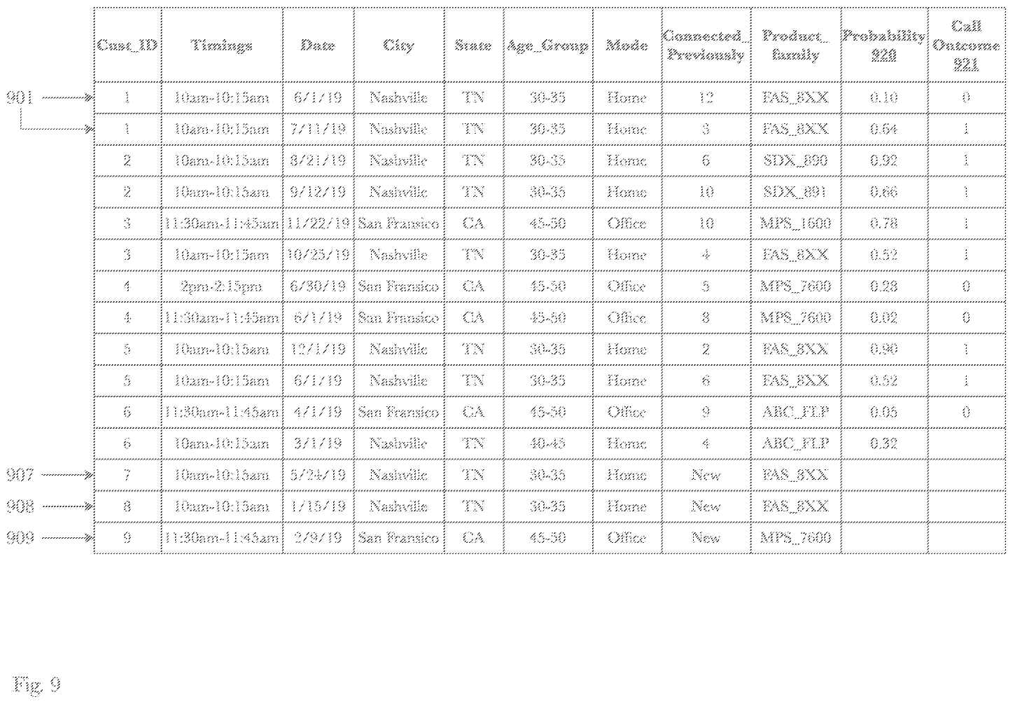

As an example, refer to FIG. 9: The probability 920 and the CallOutcome 921 has not been populated for row No. 7 907, 8 908, and 9 909 as they are the new customers. The module might find that Cust_ID 7 907 demographically very similar to Cust_ID 1 901. Hence, it will give a similar probability to Cust_ID 1 901. The persona model tries to match likely known customer demographics and characteristics with the historical instances/output and does not consider the historical or relationship features.

Still referring to FIG. 9, the following paragraphs concern the interpretation of the model outputs and the different ways they can be utilized effectively. In this section, and only in this section, BTTC stands specifically for “Best Time To Contact” and RPTC stands for “Right Person To Contact”. In all other sections, these two concepts are combined into a single definition of BTTC.

In FIG. 9, there are 9 customers and most of them have multiple occurrences across different times/dates. In this example, CallOutcome 921 (binary: 1 or 0) is the target variable and rest of the columns are features. Moreover, the CallOutcome 921 column is a formula based on the Probability (predicted) column 920; if the probability is greater than a certain amount, then the CallOutcome 921 is one, otherwise it is zero. This certain amount is the Threshold Cut-Off as desired by the user. For this example, assume the threshold is the naïve 0.5. Hence, greater than or equal to 0.5 yields CallOutcome=1 and otherwise CallOutcome=0.

The “Best Time” to contact is trained on the task of finding one or more times to contact people where they are likely to answer. Using it comprises selecting a timeslot, filtering where the CallOutcome 921 is equal to one, and order the probability. Other factors may be taken into consideration as business needs dictate.

The “Right Person” to contact is trained on the task of determining the customers most likely to answer in the given time frame. Using it comprises selecting a timeslot and arrange the probabilities in the descending order; ideally, this should be the order in which customer needs to be called unless there is a higher sorting probability defined by the business. Notice that there's no filter on CallOutcome 921; all customers with a prediction on this time slot will be available to call.

One difference between “Best Time” and “Right Person” to contact is that “Right Person” will have at least as many people to call for a timeslot than “Best Time” as “Best Time” uses an additional filter, namely “CallOutcome=1”. If “Best Time” is considered for a specified timeslot, then only one customer is available to call. Thus, with “Best Time”, it may be possible to run out of contacts to call during a given Timings window.

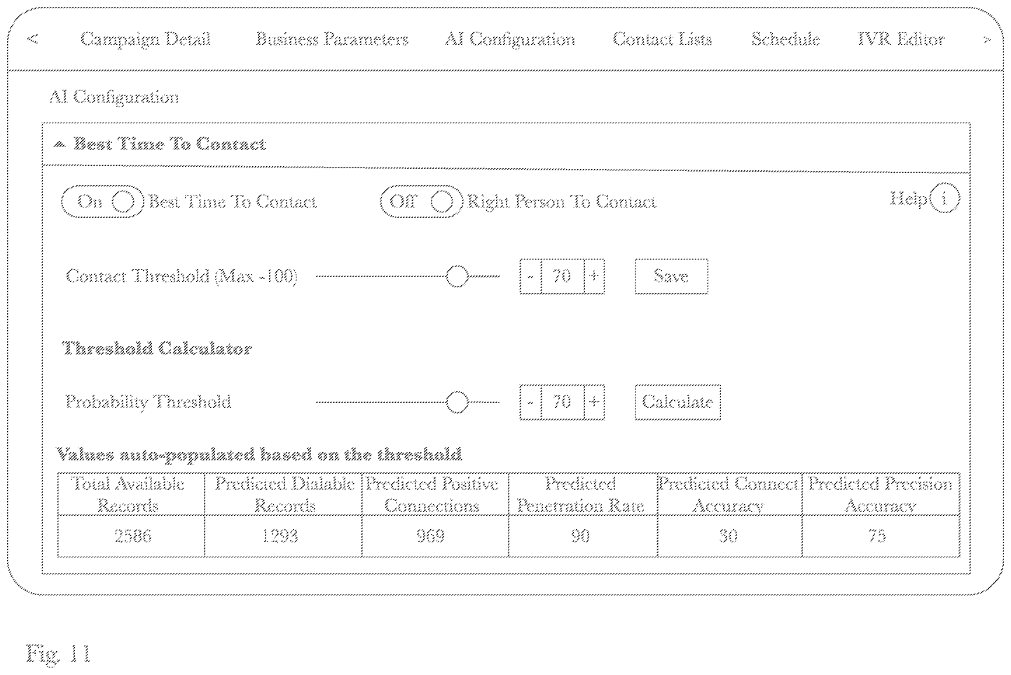

An exemplary user interface that may be provided on a propensity prediction and optimization platform is found in FIG. 11. The example user interface is what a user may find when using the BTTC module on the propensity prediction and optimization platform. Other modules may have similar user interfaces with respective choices and options as disclosed herein. This user interface is for exemplary purposes only and is not limited to the features illustrated in FIG. 11.

Moving on to an embodiment arranged to determine a propensity to churn (i.e., “P2C”) of a customer; that is, the likelihood of an individual to cease being a customer, which integrates various techniques of customer data analysis, modelling, and mining multiple concept-level associations to form an intuitive and robust approach to gauge customer loyalty and predict the likelihood of defection. This is achieved by running a series of machine learning models, the first of which divides previous and existing customers into churned (1) and non-churned (0), respectively. Based on this segregation, patterns are discovered across demographics and historical features including payment, purchasing, complaints, feedback scores, and more. Moreover, a separate model is built to estimate “tenure at time of churn” taking into account both the tenure at time of churn for previous customers and the tenure of existing customers yet to churn. These models are then applied to the existing customer base. First, the model classifies the existing customers into “likely to churn” and “not likely to churn” buckets. For those likely to churn, the second model is executed to estimate the time until churn in days relative to the current date. This process of analyzing and calculating the estimate time to churn is called as Survival Regression Analysis. The accuracy of this model is derived from correctly estimating the order of which people churn; it does not try to minimize the difference in estimated churn tenure and actual churn tenure.

The below table illustrates a list of exemplary business data categories considered while drawing the possible list of variables and scenarios that go into a model for P2C. This table is non-exhaustive and here for exemplary purposes.

| Business Category Name | Business Category Description |
|---|---|
| Customer Payment History | Past transaction history of customers are used to |
| | study and analyze the future payment patterns of the |
| | customers. This helps the business in proactively |
| | identifying and grouping customers based on their |
| | propensity to pay and expected collection amount. |
| | This also becomes an important qualifier to run |
| | collection campaigns. Customers can be prioritized |
| | on these metrics while running campaigns. |
| Similar Customers | P2P Rate across customers of similar type can be |
| | defined on customer demographics, interaction |
| | metrics, activity type, etc. Patterns on P2P from |
| | similar customer types can be mined to uncover |
| | trends that may be visible. |
| Similar Products | The likelihood to pay rate across similar products or |
| | within similar product family groups is utilized to |
| | help estimate the likelihood against a specified |
| | product. This further helps the business to feature |
| | and strategize the products based on the end goals also. |
| Similar Campaigns | The likelihood to pay rate across similar campaign |
| | types and groups can also be defined. Patterns on |
| | P2P from similar campaigns can be utilized to help |
| | understand the pay rates of the current campaign. |
| | Campaign goals can be further tied here to gauge the |
| | effectiveness of the campaigns. |
| Agent Effectiveness | Agent metadata and skill definitions can help identify |
| | a customer's likelihood to pay and expected |
| | collection amount. Businesses can further map the |
| | agent skill sets to the underlying campaigns and their |
| | P2P metrics in order to identify the right skill set |
| | group for the right set of customers. |
| Complaints | Complaint data can be consumed to understand if |
| | any patterns exist between the payment metrics and |
| | the complaints received. Quick resolutions to such |
| | cases may help in increasing the P2P Rates. |
| Specialty Programs | Understand the purchasing circumstances to see if |
| | there was any alternative benefit for the customer to |
| | make the purchase other than just the desire of the |
| | product; this includes discounts, cash back, savings, |
| | loyalty program benefits, points, flight miles, gas |
| | points, etc. The historical or continued success of |
| | these benefits might play a role in identifying |
| | payment metrics. |
| Customer Interaction History | Past interactions over voice, email and chat can be |
| | utilized to understand possible relationships between |
| | these items and payment metrics. This would help |
| | further help the business to track the pain points that |
| | customers face across these channels if any and |
| | introduce measures to improve its effectiveness. |
| Customer Feedback or NPS | Understand how the customer feels about the |
| | company; this might be estimated or have other |
| | proxies if an NPS or feedback does not exist by the |
| | customer such as sentiment analysis on conversations |
| | relating to the product, referrals by the customer to |
| | someone else, usage of products, on-time payment |
| | frequencies, similar customer NPS scores, or some |
| | other format. |

P2C models may include one or more separate models, however, according to one embodiment, two types of models are disclosed, which are a full model and a persona model. The full model will be considered for those customers who have successfully been with the company for at least three (3) billing cycles. This will look at customer's specific relationship history with the business among other features as described above in the Business Categorization section. The persona model comprises new customers with insufficient personal historical information will be considered under this model. According to one embodiment, any customer with less than three (3) billing cycles of any product is a new customer. The model will use, instead, the churn history of similar customers with longer history in combination with the customer's demographics and other features to predict the likelihood of churn for newer customers.

Furthermore, the persona model details that not every customer will have enough historical records. Some campaigns will contain brand new customers whose segmentation is a blank or null value, will have little to no history as a new customer, or will contain previously unseen values as features. That's when the model relies most on general demographics or variables related to customers' characteristics that can be generalized across similar customers. Demographic segmentation divides the market into smaller categories based on factors such as age, gender, area code, zip code, race, homeownership, and level of education etc. Specifically, demographic data relies on describing a customer without having to know contact history or any relationship details between the customer at the company. Using only these pre-known demographics about current customers and their existing payment histories to build a persona model, any campaign with new customers or new values can still utilize at least some version of a propensity to pay model.

Moving on to the Propensity to Pay (P2P) module, the P2P module will yield a set of results including the probability for non-zero payment, the propensity for non-zero payment, the proportion of the bill expected to be paid, the probabilities the customer will pay the bill across multiple time-frame options, a probability that the customer needs a reminder, a reminder needed flag (binary version of reminder probability), and the probabilities of success if a reminder is sent spanning multiple time-frame options. These are described in more detail below. Most of these results stem from a binary classification model, but the proportion to be paid is a regression-based model. A binary classification machine learning model is classifying observations into one of two classes., i.e., whether the customer is likely to make a payment or not within the stipulated time period. Moreover, a regression machine learning model is a numeric prediction and usually are less reliable to provide accurate values. These models are both compared against a host of variables on the customer such as past transaction history, interaction history, customer profile, etc. Features to be used are described in more detail in the Business Categorization section below.

The following metrics are defined by the model: Probability to pay—the probability that the customer will make any non-zero payment towards a given bill, Propensity to pay—a binary value of 1 or 0 that describes the expectation that customer will make a non-zero payment towards a given bill, Expected proportion to pay—a decimal value between 0 and 1 that describes the percentage of the billed amount that the customer is likely to pay, Expected amount to pay—the expected amount the customer will pay at the time of payment; a calculated field of the expected proportion multiplied by the billed amount, Expected time to pay—the amount of time (in terms of days) the customer will take in order to pay the outstanding dues, Recommendation to send reminder—This response is a set of 3 time values, namely pre-due date, on due date, and post-due date, and their respective binary responses of 1=“helpful” or 0=“not helpful”. A reminder is considered “helpful” differently at each time interval: 1) if the reminder is sent pre-due date and the customer pays on or before the due date, 2) if the reminder is sent on the due date, then the customer makes a payment on the due date, or 3) if the reminder is sent post-due date, then the customer makes a payment post-due date. All conditions are also subject to a “3 day” rule saying that the reminder is only helpful if the customer pays within 3 days of the reminder, and Recommended time and channel to remind—Assuming a reminder is helpful, then this responds with the combination of recommended times (as described in 6) and the channels to use (voice, email, SMS) and models to use (mobile, business, home, email ID, etc.). For each combination, there will be a binary response of 1=“recommended” or 0=“not recommended”. If a customer is recommended for a reminder and no combination is recommended, then the highest probability of time, channel, and mode combinations will always be 1.

The below table illustrates a list of exemplary business data categories considered while drawing the possible list of variables and scenarios that go into a model for P2P. This table is non-exhaustive and here for exemplary purposes.

| Business Category Name | Business Category Description |
|---|---|
| Customer Payment History | Past transaction history of customers are used to |
| | study and analyze the future payment patterns of the |
| | customers. This helps the business in proactively |
| | identifying and grouping customers based on their |
| | propensity to pay and expected collection amount. |
| | This also becomes an important qualifier to run |
| | collection campaigns. Customers can be prioritized |
| | on these metrics while running campaigns. |
| Similar Customers | P2P Rate across customers of similar type can be |
| | defined on customer demographics, interaction |
| | metrics, activity type, etc. Patterns on P2P from |
| | similar customer types can be mined to uncover |
| | trends that may be visible. |
| Similar Products | The likelihood to pay rate across similar products or |
| | within similar product family groups is utilized to |
| | help estimate the likelihood against a specified |
| | product. This further helps the business to feature |
| | and strategize the products based on the end goals also. |
| Similar Campaigns | The likelihood to pay rate across similar campaign |
| | types and groups can also be defined. Patterns on |
| | P2P from similar campaigns can be utilized to help |
| | understand the pay rates of the current campaign. |
| | Campaign goals can be further tied here to gauge the |
| | effectiveness of the campaigns. |
| Agent Effectiveness | Agent metadata and skill definitions can help identify |
| | a customer's likelihood to pay and expected |
| | collection amount. Businesses can further map the |
| | agent skill sets to the underlying campaigns and their |
| | P2P metrics in order to identify the right skill set |
| | group for the right set of customers. |
| Complaints | Complaint data can be consumed to understand if |
| | any patterns exist between the payment metrics and |
| | the complaints received. Quick resolutions to such |
| | cases may help in increasing the P2P Rates. |
| Specialty Programs | Understand the purchasing circumstances to see if |
| | there was any alternative benefit for the customer to |
| | make the purchase other than just the desire of the |
| | product; this includes discounts, cash back, savings, |
| | loyalty program benefits, points, flight miles, gas |
| | points, etc. The historical or continued success of |
| | these benefits might play a role in identifying |
| | payment metrics. |
| Customer Interaction History | Past interactions over voice, email and chat can be |
| | utilized to understand possible relationships between |
| | these items and payment metrics. This would help |
| | further help the business to track the pain points that |
| | customers face across these channels if any and |
| | introduce measures to improve its effectiveness. |
| Customer Feedback or NPS | Understand how the customer feels about the |
| | company; this might be estimated or have other |
| | proxies if an NPS or feedback does not exist by the |
| | customer such as sentiment analysis on conversations |
| | relating to the product, referrals by the customer to |
| | someone else, usage of products, on-time payment |
| | frequencies, similar customer NPS scores, or some |
| | other format. |

P2P models may include one or more separate models, however, according to one embodiment, two types of models are disclosed, which are a full model and a persona model. The full model will be used to describe those customers who have an occurrence of at least five (5) billing cycles. When described this way, the features will look at the individual customer's relationship history with the business among other features as described above in the Business Categorization section. The persona model details new customers, that is those with less than five (5) billing cycles, is assumed to have insufficient personal historical information to be considered in the machine learning model. Instead, clustering will be used to define similar customers and, using their aggregated history information, simulate the individual customer's history for the machine learning model.

In detail, the persona classification means the historical information of similar customers with longer history will be used in combination with the customer's demographics and other features to predict the different probabilities for the P2P model.

Populating probabilities and predicting the outcomes for Incumbents/Existing Customers is relatively easier than dealing with a new customer as they have insufficient personal history to be considered trustworthy and non-biased. The solution to this is finding similar customers for each of the new customers using Clustering and filling out their information from the obtained aggregated results. The aim of cluster analysis is to organize observed data into meaningful structures in order to gain further insight from them. Specifically, “KMeans” clustering model may be used as a supervised methodology to classify new customers as generic types of existing customers and assuming aggregations of those existing customer attributes against the new customers to use in predictions.

A feature to remind customers to pay is anticipated and described as follows. Channels used for reminders could be post mail, email, SMS, Interactive Voice Response (IVR), instant messaging, social media, or voice. A company presumably prefers their customers to be reliable. However, the company is not the only one who loses value when payments are missed. A large loss of value to the customer might be a blemished credit history or lower credit score which adversely impacts the customer's chance of availing any credit faculty in the future.

According to one aspect, blanketing all customers with reminders may not be the best approach due to operational limitations, cost inefficiencies, or potential negative customer experiences. In order to optimize company resources, the model may focus the resources first on customers where a reminder is likely to help. Such an implementation may remove both customers that do not need reminders and customers where reminders fall on deaf ears.

A task of the model is then to identify if a reminder is likely to be effective at multiple time frames within the billing cycle for each customer. For example, suppose Customer A has historically had trouble paying the bill at all. However, on the subset of instances where the customer received a reminder, the customer has a higher probability of payment than when no reminder is sent. The model will predict that Customer A needs a reminder.

Now suppose Customer B is a person that has historically always paid the bill on time. Suppose also that for current billing cycle, the payment happens to be late. The machine learning model might predict a reminder necessary after considering how many reminders have already been sent, today's date relative to the due date, the customer's personal payment history timing, and patterns extracted across similar customers.

The features used for this model contains the standard data points of customer demographics, personal historical payments, similar customer historical payments, product data, payment methods, complaint data, NPS or feedback data, etc., along with reminder history and effectiveness. The Target of this model is “Reminder Helpful” which is a binary (0,1) value—where the value would be a 1 if a reminder was sent and was deemed helpful, else 0—defined by the following conditions: Customers with no previous reminders, Customers with reminders sent for all previous bills, Customers that explicitly opt for a reminder or no reminder, Customers that consistently do not pay bills or have been sent to collections, and Customers who have historically or currently opted for AutoPay. Exemplary dataset definitions may comprise: Training data primary key needs to be at the “reminder sent” level, Reminder are classified as outbound communication through any channel including but not limited to SMS, email, and voice, Time is divided into categories (three by default): “pre-due date”, “on due date”, and “post-due date”, and the target, “Reminder Helpful” is calculated for every reminder sent. Regarding the reminder helpful; If Reminder is sent “Pre-Due Date” and customer pays the bill in the next N number of days defined by the user and the bill was paid on or before the due date, then the reminder was effective, If Reminder is sent “On Due Date” and customer pays the bill on the same day i.e., the due date, then the reminder was effective, If Reminder is sent “Post Due Date” and customer pays the bill in the next 3 days, the reminder was effective, otherwise, the reminder was not effective. The model yields an output, “Send Reminder”, of a probability between 0 and 1 that the customer is more likely to pay with a reminder than without one. This can use a cut-off threshold to turn the probability decimal into a binary value of 0 or 1. This threshold can be chosen in several ways, as known to those in the art.

The following is a table of exemplary features that may be considered for analysis:

| | | |
|---|---|---|
| CustomerID | TransactionDate | ChannelID |
| CustomerIsActive | ProductLifeCycle | BillAmount |
| DueDate | NewCustomerFlag | TransactionAmount |
| ProductFamily | InteractionID | BillAmount |
| InteractionStartTime | InteractionThreadID | DueAmount |
| CallBackAttemptType | ResolutionThreadID | ReminderFlag |

Other features of Propensity to pay data fields may comprise the following non-exemplary list of: Due Dates, Customer IDs, Payment Dates, exhaustive Payment Times, Billing Cycle, Product, Customer Birth Age, Gender, Nationality, Education Status, Employment Status, Occupation, Zip Code, State, Region, Income, emails, and phone numbers.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, models or the like may be described in a sequential order, such processes, methods and models may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or model is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “Customer Churn” is defined as the loss of one or more customers from the entire company.

### Conceptual Architecture

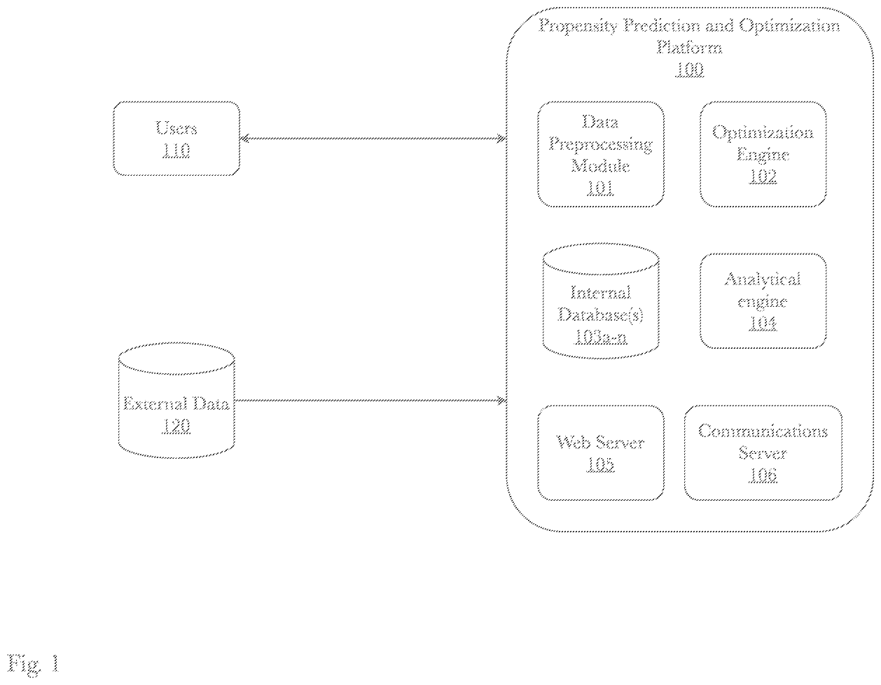

FIG. 1 is a block diagram illustrating an exemplary system architecture for a propensity prediction and optimization platform. According to one embodiment, the system 100 comprises a data preprocessing module 101, an optimization engine 102, one or more internal databases 103a-n, an analytical engine 104, a web server 105, and a communications server 106. Users 110 in this diagram is referring to users (typically, but not limited to businesses) of the Propensity Prediction and Optimization Platform 100, as opposed to customers, where customers are the patrons of the users (businesses), and customers, or more specifically customer's data, is the data used by the Propensity Prediction and Optimization Platform 100. In some cases data about the users/businesses may be incorporated as well. As stated above, Users are typically businesses, these businesses may or may not have their own client database 120. The Propensity Prediction and Optimization Platform 100 may agglomerate data 120 from one or more of the users 110 and other sources of data 120 (e.g., public and private data stores) in order to combine profiles of patrons that exist across one or more users. For example, if a grocery chain and a bank are both users of the system 100, and both share a patron by the name of John Doe who is registered in both the grocery chain and bank's databases, then the system 100 may identify that John Doe is the same person and combine, at least logically, the two profiles. This will increase the precision and accuracy of the predictions and optimizations provided by the system 100 and method.

The web server 105 may comprise an API (Application Programming Interface) or other communication means by which users may interact or query, the Propensity Prediction and Optimization Platform 100. Communication between the Propensity Prediction and Optimization Platform 100 and users may be via the Internet, a WAN, LAN, Wifi, PSTN, or other communication vehicle.

The Propensity Prediction and Optimization Platform 100 further comprises a data preprocessing module 101 that will automatically ingest and transform external 120 and internal data 103a-n for use with the machine learning modules/models present in the analytical 104 and optimization 102 engines. Internal databases 103a-n may comprise a routing database, a campaign database, a historical database, a customer database, or other databases as needed. The communications server 106 comprises various communications services used to send and receive standalone communications to and from the system 100 or communications from the webserver 105. For example, the communications server 106 may make use of email; instant messaging; social media messaging; VoIP, CMDA, GSM, PSTN, and other types of voice protocols; and text messaging protocols such as SMS, MMS, iMessage, and RCS.

The analytical engine 104 uses one or more machine learning modules/models with data 103a-n/120 to make predictions about a plurality of metrics concerning customers. The optimization engine 102 uses the aforementioned predictions to optimize customer engagement. Customer engagement in this sense may be used to provide workflows of business operations, but more importantly, the optimized workflows may be tied into existing call center systems. For example, optimizations may comprise prioritized lists of contacts that auto dialers use to communicate with contacts. Optimizations may also be tied into existing call center tasking systems wherein tasks given to agents, typically in the form of a list on the agent's computing device, may change on the fly based on the optimizations.

A more specific example is when a user of the system requests for a day's tasks, the system for predicting propensities and optimizing tasks (i.e., a propensity prediction and optimization platform) receives a plurality of customer records, typically uploaded by the user or an administrator. The system stores the plurality of customer records to use in the machine learning models to predict the most probable block of time of each day each customer in the plurality of customer records will engage in communication; predict the most probable means of communication for each block of time for each customer in the plurality of customer records, the means of communication is selected from the group consisting of email, text messaging, instant messaging, and phone calls; predict the propensity to churn for each customer in the plurality of customer records; and predict the probability of each customer in the plurality of customer records to pay a bill. Those predictions are used to sort the plurality of customer records according to one or more predetermined objectives. Those objectives may comprise many goals, some examples are determining the customers with highest propensity to pay and the highest outstanding balance, and customers who are most likely to churn. Extending on the example of customers who are most likely to churn, a further evaluation may also include which of those customers most likely to churn have paid the most amount of money to the business, and prioritize those customers. Adding even more factors, all the aforementioned objectives may also be evaluated against who is most likely to answer a communication. So, between two customers who both owe a substantial amount, and both are likely to pay, one customer may likely not answer within the next hour while the other customer might. The latter customer would obviously be a higher priority according to one embodiment. Many objectives may be imagined by those with minimal skill in the art.

This ordered list may be dynamic and continuously update. Auto dialers and computing systems may receive one or more records from the sorted list. For example, if a call center has twenty agents, each having his or her own computing system with an auto dialer and user interface, each computing system may receive one or more customer records from the list. For example, the first (highest priority) twenty records may be sent to one of the twenty auto dialers, along with the purpose of the call. One record may be sent to the auto dialer that is in need of collections and that information (that it is a collections call) is sent to the computing device's user interface such that the call center agent knows the purpose of the call. A different call center agent may receive a task of a retention call, this agent's auto dialer receiving the high-probability-to-churn customer record. Auto dialers are understood to be phone calls but likewise, the system may use the sorted customer records to auto generate emails, text messages, and instant messages.

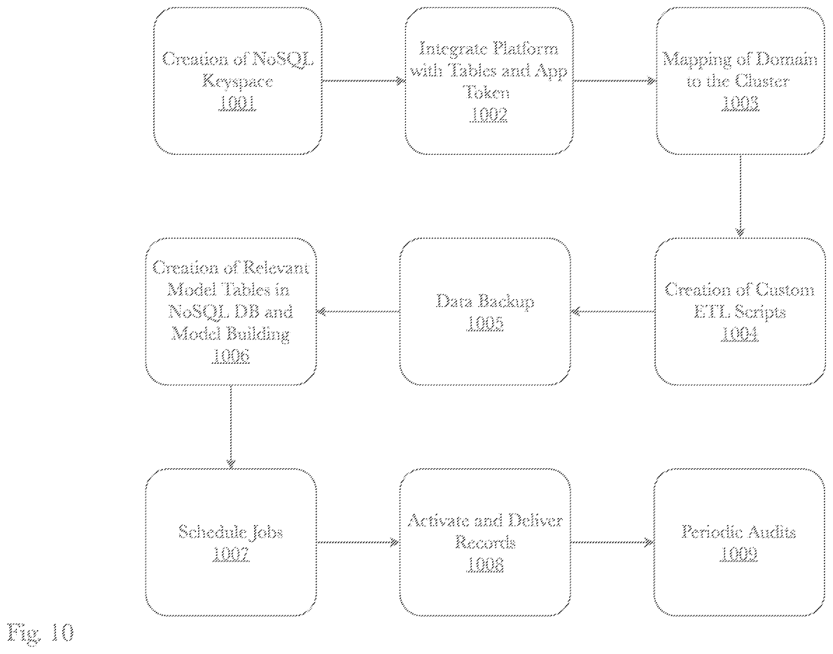

Furthermore, and according to one embodiment, the system and method comprises automated iterative processes. A first process is by default set to run weekly, but is configurable, and entails one or more of the models described herein being retrained on new data. This may comprise choosing which features are most important, tuning the model hyper-parameters, choosing the most effective model family, establishing metric expectations in production, and notifying the business of expected changes and recommend validation of thresholds. A second automated iterative process is set by default to run nightly, or during off-peak hours, which comprises pulling data from external resources, running formulas to generate features that one or more of the models expect, store a history of customer snapshots in time, update customer profiles based on the most recent data, and run the Propensity to Churn model on customers who changed during the day. Additional details disclosing the steps 1001-1009 for a quick on-boarding process for users and integration into existing business/call center systems is found in FIG. 10.

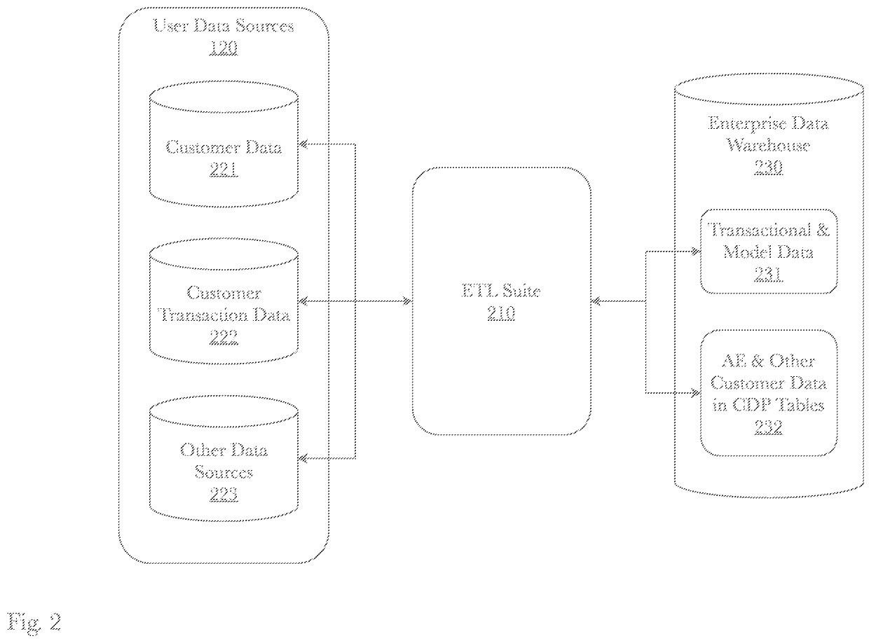

FIG. 2 is a block diagram illustrating an exemplary data architecture used in a propensity prediction and optimization platform. The data generated by consumers of a product/service are collected and stored in databases. This information is aggregated and modelled to enable Machine Learning modules to predict business outcomes for an enterprise.

For example, the Best Time To Contact (BTTC) ML program will predict what is the best channel and time to initiate a conversation with a customer; the Propensity To Churn (P2C) ML program will predict the likelihood of customers churning a product/organization and enable the platform to run a campaign based on that.

User data sources 120 (customer data 221, customer transaction data 222, and other data sources 223) are scheduled as desired for push/pulls into the enterprise data warehouse 230. According to one embodiment, two databases are used to store information. One is a relational database 232 (e.g., MS SQL Server, etc.) and the other is a NoSQL database 231 (e.g., Cassandra, etc.)

The interactions (meta-data about calls, emails, webchat, etc.) that customers have with the enterprise and the customer master information are stored in a relational database system 232. This information is used for retrieving information about an interaction and to summarize them. The interactions related to outbound campaigns are generated from the Engagement product and are stored in this database. Other interactions such as incoming voice calls or emails will be extracted and loaded from other systems using ETL scripts 210.

The transaction information (customers using a product or a service such as using a credit card) is typically large and hence stored in a NoSQL database system 231. This information is combined with the interactions to build machine learning models and statistical models to predict customer behavior, identify potential areas of sales and service improvements, improve productivity or business operations, etc. This information is extracted and loaded from customer's data warehouse/systems using ETL scripts 210.

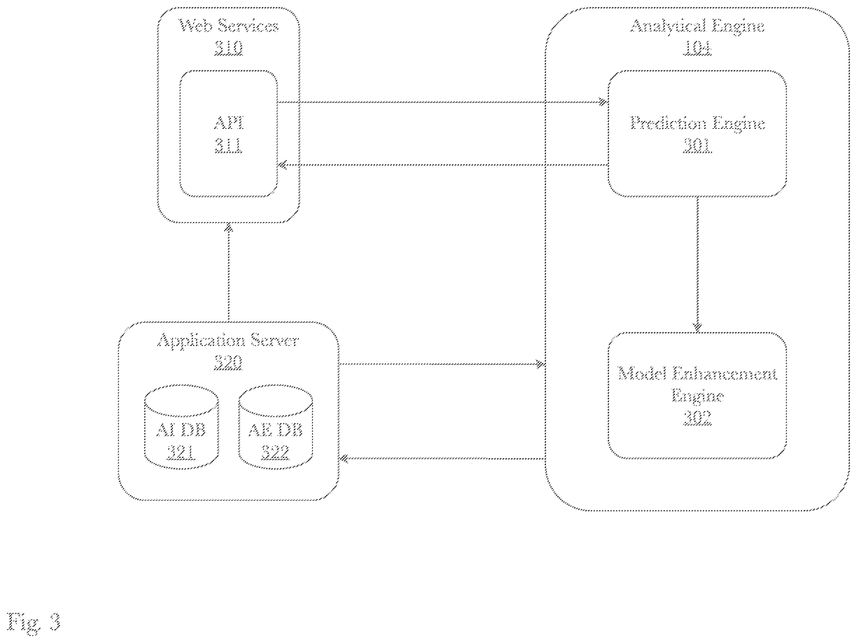

FIG. 3 is a block diagram illustrating an exemplary analytical engine used in a propensity prediction and optimization platform. Web services 310 utilizing an API 311, such as DJANGO REST FRAMEWORK™ as one example, communicates with the analytical engine (APACHE SPARK as one example) via TCP/IP. The prediction engine 301 predicts probability across all timeslots and modes provided for contacts. In a next step, results are saved against both an AI database 321 and an AE database 322. A response with database metadata is generated by the prediction engine 301 so the analytic engine 104 knows where data was saved. The prediction engine 301 further updates the internal AI DB 321 on feedback data to be used for model fine-tuning. After updating, the models are enhanced by the model enhancement engine 302. This is accomplished by using reverse feedback data to continuously fine-tune the predictions model. Also, to review performance at scheduled intervals and use dynamic scheduling based on data volume and dynamicity. Data is read and written from the analytical engine 104 to an analytical engine application server 320 which further fulfills API 311 requests between web services 310.

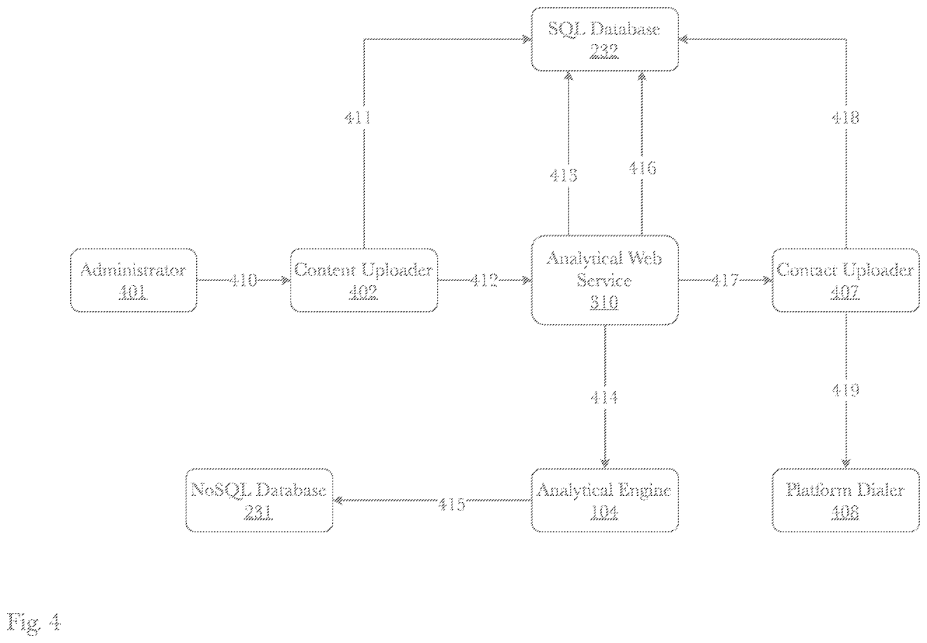

FIG. 4 is a block diagram illustrating an exemplary machine learning architecture in a propensity prediction and optimization platform. In a first step 410 an administrator 401 creates the campaign, sets the pacing mode and uploads using a content uploader 402, the intended records into the system. Once the records are uploaded, they are stored 411 in the SQL database 232. An API request gets prediction time for given contacts and informs 412 the analytical web service 310 about the data upload. The analytical webservice retrieves the data from a given table 413. The analytical webservice passes the data to the analytical engine 104 for predictions 414. Predictions are done on the past transaction history and other information stored 415 in the NoSQL database 231. Once predictions are complete, the analytical web service writes 416 the prediction results back to the SQL database 232. In a next step, the analytical web service triggers web-hooks once prediction scores are available 417. Once the prediction scores are retrieved by the contact uploader 407, it activates the contacts for dialing 418. Once activated, identified records are delivered to the dialer 408 for dial out 419.

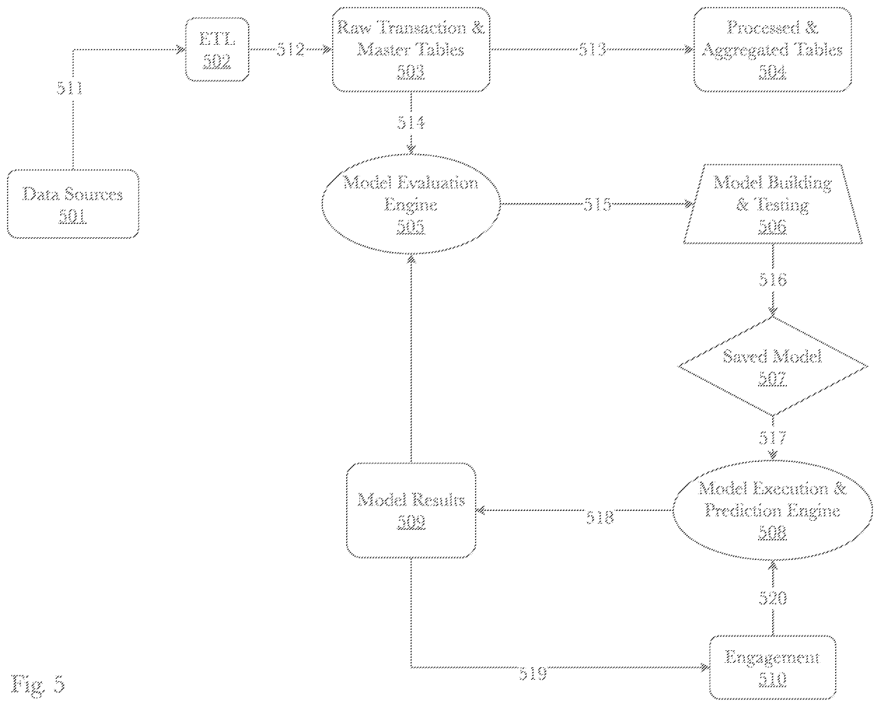

FIG. 5 is a flow diagram illustrating an exemplary implementation of a propensity prediction and optimization platform. Data sources 501 are 511 extracted, transformed, and loaded 502 periodically 512 into raw transactions and master tables 503. Periodic automatic updates are sent 513 to the processed and aggregated tables 504 for each model. Feedback data is incorporated 514 into a model evaluation engine 505 where model fine-tuning and enhancement 515 is used in model building and testing 506. Models 507 are saved 516 which are used 517 with a model execution and prediction engine 508. Predicted results on new data 518 are the model results 509 which work 519 for engagement 510 that invokes model on the new data 520.

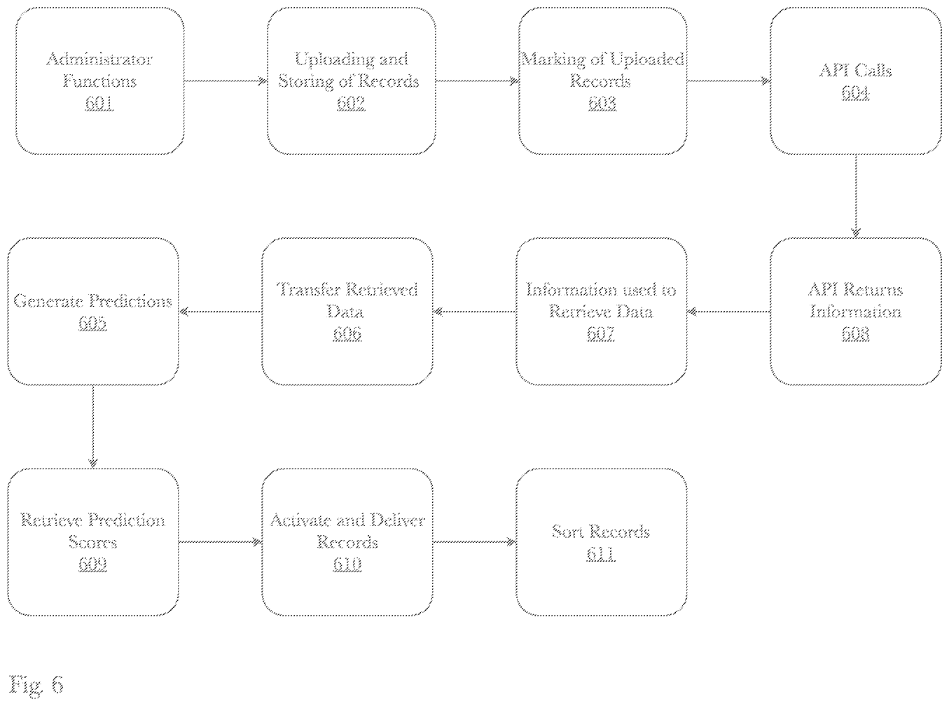

FIG. 6 is a flow diagram illustrating an exemplary method for predicting and optimizing customer propensities. An administrator creates the campaign set, pacing mode, and uploads records to the campaign 601. Once records are uploaded, they are stored in a SQL database 602. The uploaded records are marked as “pending prediction,” so they are not dialed out 603. Once the records are available, the analytical ambition calls the analytical web service APIs 604. The API call informs the analytical web service of the availability of the records in the database 605. Once the web service learns about the data availability, it retrieves the data 606. This retrieve data is sent to the analytical engine to derive the prediction score for the uploaded records 607. The analytical engine uses all previous transaction history, purchase history, etc. for the predictions 608. Once predictions are available the analytical engine retrieves the prediction scores for the uploaded records 609. Once prediction scores are updated records are delivered to the dialer 610. Records are filtered and sorted based on the threshold value defined by the administrator in the user interface 611.

### Detailed Description Of Exemplazy Aspects

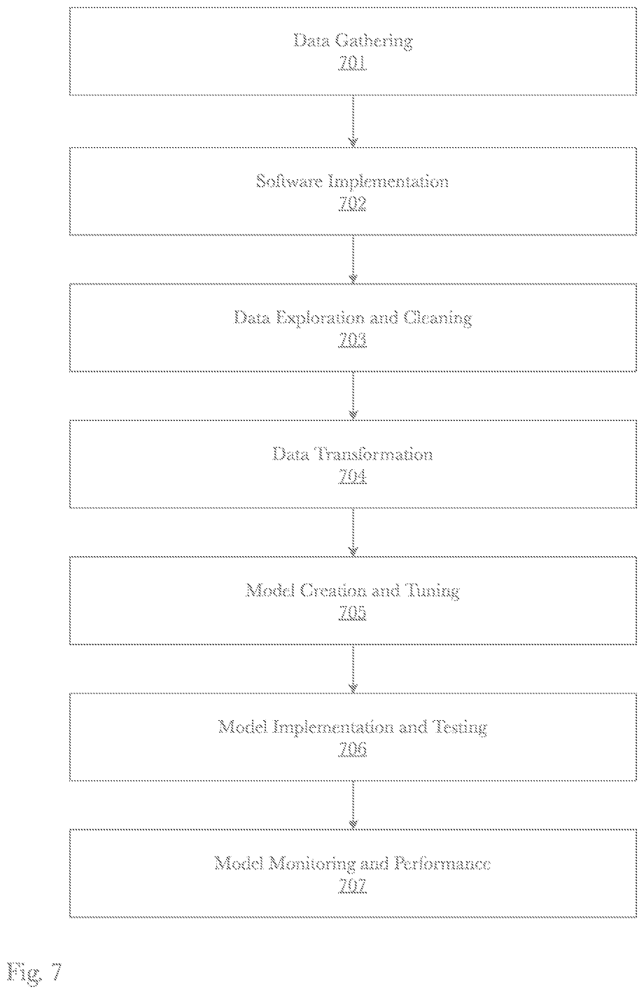

FIG. 7 is a flow diagram illustrating one aspect of an exemplary implementation of the method for predicting and optimizing of customer propensities. Data gathering comprises assessing data sources and pulling data from external databases into internal databases 701. In the next step 702, the software implementation comprises installing and configuring dockers, creating and configuring hardware, and configuring the access. Next, data exploration and cleaning is used to validate assumed relationship patterns and uncover hidden relationships 703. Data transformation extracts, transforms, and loads into modeling format while also creating formulas to pull signals and reduce noise 704. Model creation and tuning comprises experimenting with model family types, tuning each family type, selecting appropriate models, and assessing project production performance 705. In the model implementation and testing step, the models are deployed, tested and validated 706. Lastly, model monitoring and performance performs re-tuning at specific intervals, sets up reports, feedback, and alerts for continuous improvement 707.

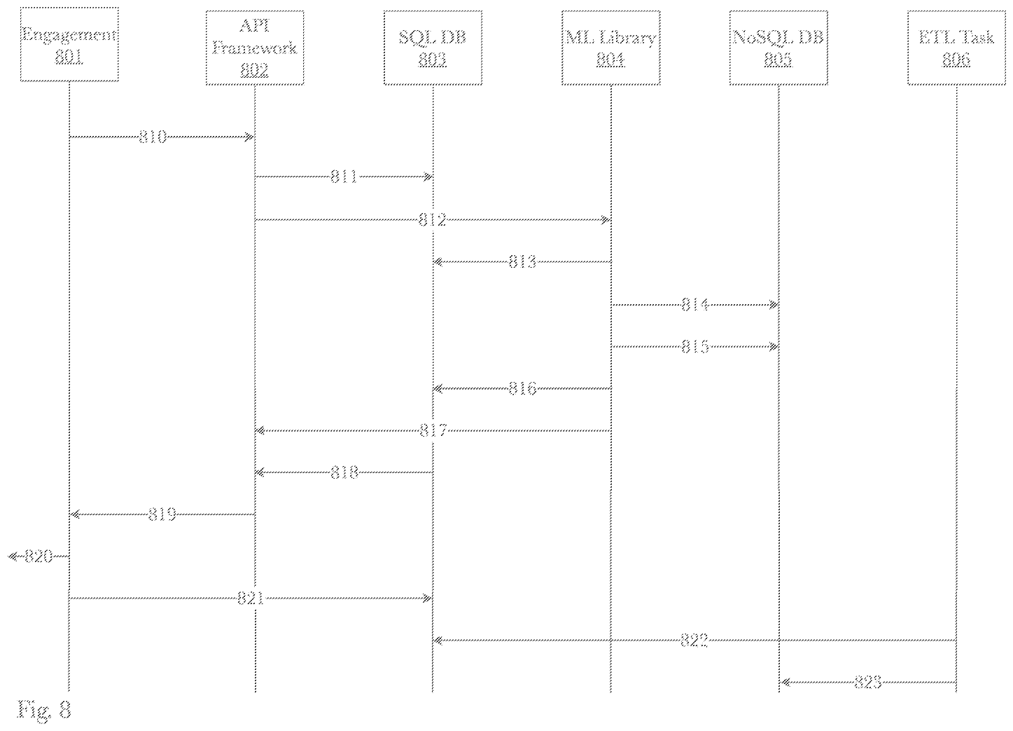

FIG. 8 is a flow diagram illustrating another aspect of an exemplary implementation of the method for predicting and optimizing of customer propensities. Engagement 801 sends list information and invokes machine learning model 810 to the API framework 802. The API Framework 802 stores the information and creates a job table 811. The API framework 802 also invokes the Machine Learning Library 804 for the model to execute, passing the job table for reference 812. The Machine Learning Library 804 reads the contact information 813 from the SQL database 803. The Machine Learning Library 804 now uses the model data and process data to execute the model for every contact 814. Further, the Machine Learning Library 804 stores the output in the NoSQL database 805 for updating with the feedback data 815. The Machine Learning Library 804 then stores 816 the machine learning output in the SQL database 803. The Machine Learning Library 804 in a next step notifies of job completion 817 to the API framework 802. The SQL database 803 then reads data from the job table 818, and the API framework 802 passes the prediction results 819 to the engagement 801. The engagement 801 then attempts to call customer 820, meanwhile contact attempts are updated 821 for the campaign to the SQL database 803. ETL tasks 806 comprise reading the contact information 822 from the SQL database 803 and updating feedback to store actual values against predicted values 823 in the NoSQL database 805.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

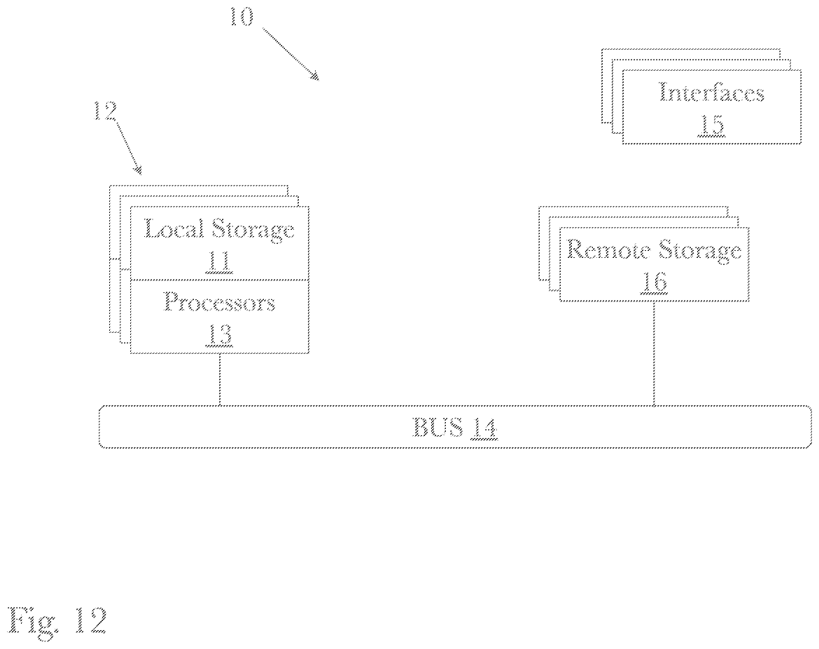

Referring now to FIG. 12, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 12 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

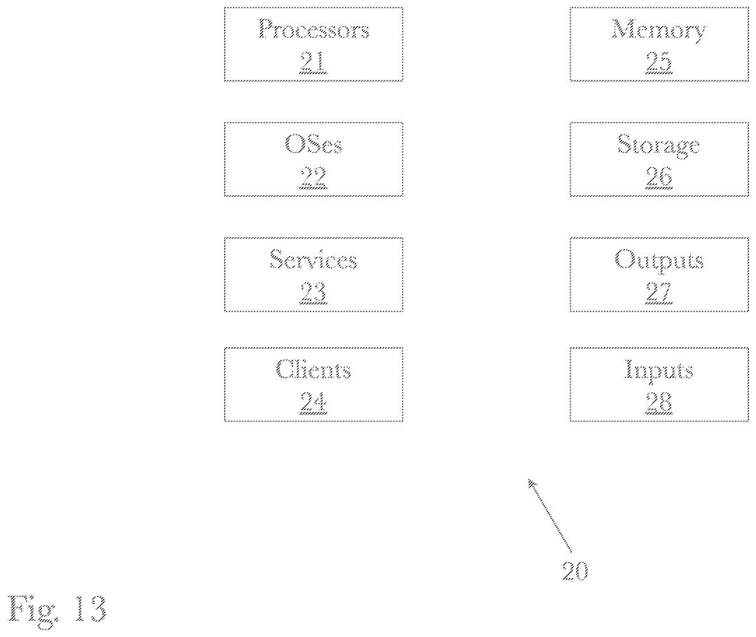

In some aspects, systems may be implemented on a standalone computing system. Referring now to FIG. 13, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 12). Examples of storage devices 26 include flash memory, magnetic hard drive, CD-ROM, and/or the like.

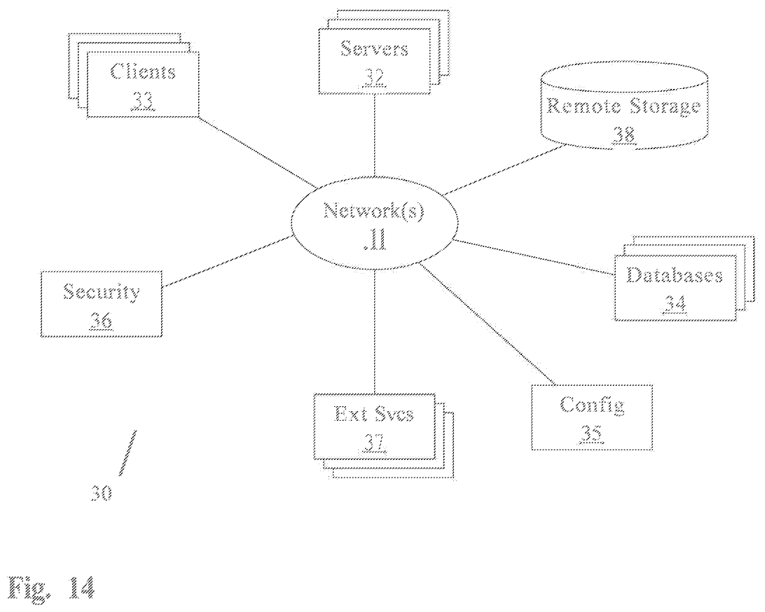

In some aspects, systems may be implemented on a distributed computing network, such as one having any number of clients and/or servers. Referring now to FIG. 14, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 13. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

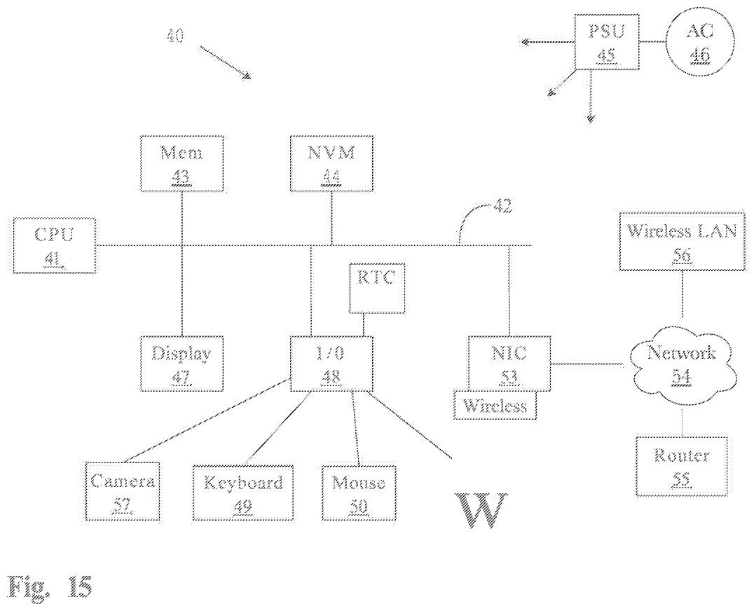

FIG. 15 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

1. A system for predicting propensities and optimizing tasks related thereof, comprising:
a computing device comprising a memory, a processor, and a non-volatile data storage device;
a machine learning library stored on the non-volatile data storage device, the machine learning library comprising:
a first machine learning model configured to predict best times to call customers, the best times to call each comprising a likelihood that a customer will answer an attempted contact at a given call time using a given a call mode;
a second machine learning model configured to predict propensities of customers to churn, the propensities to churn each comprising a likelihood that customer will cease to be a customer of a business within a given period of time;
a third machine learning model configured to predict propensities of customers to pay, the propensities to pay each comprising a likelihood that a payment will be made and an estimated amount of the payment;
a prediction engine comprising a first plurality of programming instructions stored in a memory of, and operating on at least one processor of, a computing device, wherein the first plurality of programming instructions, when operating on the at least one processor, causes the computing device to:
receive a plurality of customer records for a plurality of customers;
retrieve each of the first machine learning model, the second machine learning model, and the third machine learning model from the machine learning library;
process the plurality of customer records through the first machine learning model to predict a best time to call each of the plurality of customers;
process the plurality of customer records through the second machine learning model to predict a propensity to churn of each of the plurality of customers;
process the plurality of customer records through the third machine learning model to predict a propensity to pay of each of the plurality of customers;
select a subset of the plurality of customer records according wherein each customer record of the subset:
exceeds a first minimum threshold for the likelihood that a customer will answer the attempted contact;
exceeds a second minimum threshold for the likelihood that a payment will be made;
exceeds a third minimum threshold of the amount of payment;
falls below a first maximum threshold for the likelihood that the customer will cease to be a customer of a business within the given period of time; and
using a communication device, contact each of the customers of the subset at the given call time using the given a call mode.

2. The system of claim 1, wherein the communications device is an auto dialer.

3. The system of claim 1, wherein the communications device auto-generates a communication selected from the group consisting of email, text messaging, social media, interactive voice response, phone call, push notifications, and instant messaging.

4. The system of claim 1, wherein the communications device is a call center computing device.

5. The system of claim 1, wherein predictions are made using previously stored customer records.

6-7. (canceled)

8. The system of claim 1, wherein data between the communications device and the propensity prediction and optimization platform is facilitated by an application programming interface.

9-10. (canceled)

11. A method for predicting propensities and optimizing tasks related thereof, comprising the steps of:
storing a machine learning library on a non-volatile data storage device of a computing device comprising a memory, a processor, and the non-volatile data storage device, the machine learning library comprising:
a first machine learning model configured to predict best times to call customers, the best times to call each comprising a likelihood that a customer will answer an attempted contact at a given call time using a given a call mode;
a second machine learning model configured to predict propensities of customers to churn, the propensities to churn each comprising a likelihood that customer will cease to be a customer of a business within a given period of time;
a third machine learning model configured to predict propensities of customers to pay, the propensities to pay each comprising a likelihood that a payment will be made and an estimated amount of the payment;
performing the following steps using a prediction engine operating on the computing device:
receiving a plurality of customer records for a plurality of customers;
retrieving each of the first machine learning model, the second machine learning model, and the third machine learning model from the machine learning library;
processing the plurality of customer records through the first machine learning model to predict a best time to call each of the plurality of customers;
processing the plurality of customer records through the second machine learning model to predict a propensity to churn of each of the plurality of customers;
processing the plurality of customer records through the third machine learning model to predict a propensity to pay of each of the plurality of customers;
selecting a subset of the plurality of customer records wherein each customer record of the subset:
exceeds a first minimum threshold for the likelihood that a customer will answer the attempted contact;
exceeds a second minimum threshold for the likelihood that a payment will be made;
exceeds a third minimum threshold of the amount of payment;
falls below a first maximum threshold for the likelihood that the customer will cease to be a customer of a business within the given period of time; and
using a communication device, contact each of the customers of the subset at the given call time using the given a call mode.

12. The method of claim 11, wherein the communications device is an auto dialer.

13. The method of claim 11, wherein the communications device auto-generates a communication selected from the group consisting of email, text messaging, social media, interactive voice response, phone call, push notifications, and instant messaging.

14. The method of claim 11, wherein the communications device is a call center computing device.

15. The method of claim 11, wherein predictions are made using previously stored customer records.

16-17. (canceled)

18. The method of claim 11, wherein data between the communications device and the propensity prediction and optimization platform of claim 11 is facilitated by an application programming interface.

19-20. (canceled)
